(19) United States
(12) Patent Application Publication
(10) Pub. No.: US 2007/0162212 A1
(43) Pub. Date: Jul. 12, 2007

(54) METHOD FOR ESTIMATING IN REAL TIME A FRONT EFFORT AND A REAR EFFORT APPLIED BY THE GROUND TO A VEHICLE

(75) Inventors: Marco Pengov, Rueil Malmaison (FR); Donald Margolis, El Marcero, CA (US); Basar Ozkan, Davis, CA (US)

Correspondence Address: NICOLAS E. SECKEL;Patent Attorney, 1250 Connecticut Avenue, NW Suite 700, WASHINGTON, DC, 20036, US

(73) Assignee: PEUGEOT CITROEN AUTOMOBILES SA, Velizy-Villacoublay (FR)

(21) Appl. No.: 11/608,344

(22) Filed: Dec. 8, 2006

(30) Foreign Application Priority Data
Dec. 8, 2005 (FR) 0553787

(51) Int. Cl. B62D 6/00

(52) U.S. Cl. 701/69; 701/82; 701/42

(57) ABSTRACT

The invention concerns a method for estimating in real time, in a motor vehicle, a front force (F_{yV}) and a rear force (F_{yR}), these forces being applied by the ground to the front wheels and to the rear wheels, respectively, of the vehicle along a transverse direction. The method consists in:
equipping this vehicle with a measuring device supplying a signal representative of a measured transverse acceleration (γ_{T}) and a signal representative of a measured yaw rate (γ_{T}), and with a processing unit; applying to these signals a processing operation to determine a front force and a rear force based on a dynamic model of the vehicle such as a model of the bicycle type. The invention applies to the field of active safety.

This application claims priority of French application No. 05 53787 filed Dec. 8, 2005, which is incorporated by reference herein in its entirety.

The invention concerns a method for estimating in real time on a vehicle in motion a front transverse force applied by the ground to the front wheels, and a rear transverse force applied by the ground to the rear wheels of this vehicle.

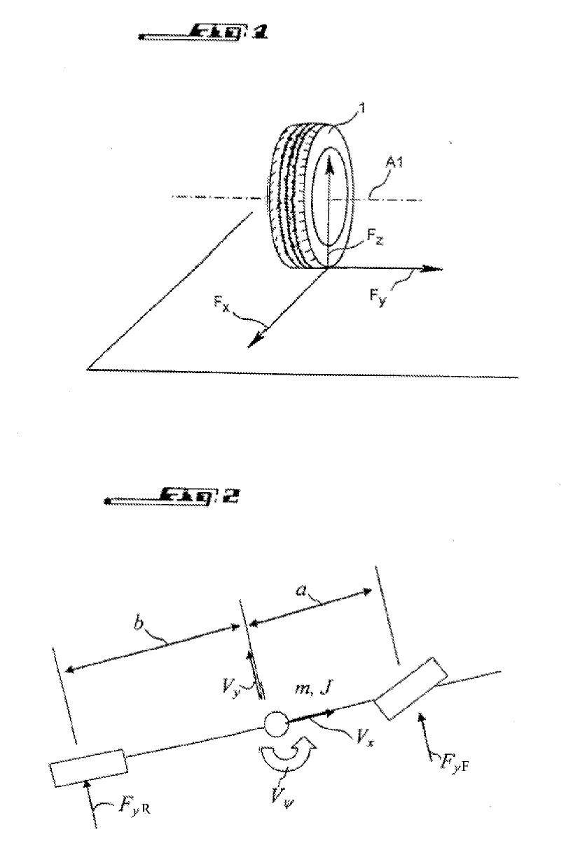

The forces transmitted by the ground to a wheel of the vehicle can be decomposed along three directions. As illustrated on FIG. 1, these threes components are a longitudinal force Fx oriented along the direction of movement of the vehicle, a transverse force Fy oriented horizontally perpendicularly to the longitudinal direction, i.e., parallel to the axis A1 of the wheel 1, and a vertical force Fz, also called load of the wheel 1.

Improving the comfort and the active safety requires knowing in real time the longitudinal and transverse forces of the front wheels and of the rear wheels. Knowing them makes it possible, for example, to monitor the position, the speed, and the acceleration of the vehicle, and, more generally, the behavior of this vehicle by acting on driven components such as the brakes, the engine, the active steering, or the suspensions.

However, the longitudinal and transverse forces cannot be measured in real time in a direct way at a cost compatible with the mass production of a high number of vehicles. Therefore, indirect methods are used, for example, consisting in regulating another variable that can be measured in real time.

This other variable is, for example, the transverse position of the upper portions of the wheels which is representative of their camber angle; the transverse acceleration of the vehicle; the yaw rate of the vehicle, i.e., its rotation speed about a vertical axis; or the angle of the steering wheel.

These indirect methods are satisfactory for the longitudinal dynamics, but not for the transverse forces.

The estimation of the transverse forces can be performed with open-loop estimation methods using various measurements in association with a model of the tire.

However, the transverse forces are a function of the drifts of the tires, of the steering and camber angles of the wheels, and of the load on each wheel. In addition, the drifts of the tires depend for their part on the longitudinal and transverse velocities of the vehicle as well as on the position of the center of gravity of the vehicle, so that the open-loop estimation methods are not sufficiently reliable.

The goal of the invention is to propose a method that makes it possible to estimate the transverse forces in real time in a reliable manner.

To this effect, an object of the invention is a method for estimating in real time, in a motor vehicle, a front force and a rear force, these forces being applied by the ground to the front wheels and to the rear wheels, respectively, of the vehicle along a transverse direction, this method consisting in:
equipping the vehicle with a measuring device supplying a signal representative of a measured transverse acceleration and a signal representative of a measured yaw rate, and with a processing unit;
applying to these signals, in the processing unit, a processing operation of determination of the front force and of the rear force based on a dynamic model of the vehicle such as a model of the tireless bicycle type defined in particular by a front wheel base, a rear wheel base, a mass, and a yawing moment, to supply a signal representative of the estimated front force and of the estimated rear force.

According to a characteristic of the invention, the processing operation includes a feedback loop, and implements a dynamic model that makes it possible to determine a transverse acceleration and a yaw rate from a front force and a rear force, and consists in:
applying to the signals representative of the estimated front force and of the estimated rear force a processing operation based on the dynamic model to form a signal representative of an estimated transverse acceleration and a signal representative of an estimated yaw rate;
forming a first discrepancy signal representative of the difference between the measured and estimated transverse accelerations, and a second discrepancy signal representative of the difference between the measured and estimated yaw rates;
forming the signal representative of the front force by combination of a signal stemming from a processing operation such as a proportional and/or integral processing operation applied to the first discrepancy signal, with a signal stemming from a processing operation such as a proportional and/or integral processing operation applied to the second discrepancy signal;
forming the signal representative of the rear force by combination of a signal stemming from a processing operation such as a proportional and/or integral processing operation applied to the first discrepancy signal, with a signal stemming from a processing operation such as a proportional and/or integral processing operation applied to a second discrepancy signal.

According to another characteristic of the invention:
the signal representative of the front force is obtained by a linear combination of a signal stemming from a proportional processing operation applied to the first discrepancy signal, with a signal stemming from a proportional and integral processing operation applied to the second discrepancy signal;
the signal representative of the rear force is obtained by another linear combination of a signal stemming from a proportional processing operation applied to the first discrepancy signal, with a signal stemming from a proportional and integral processing operation applied to the second discrepancy signal.

According to another characteristic of the invention, the method is discretized, and consists in determining a new estimated front force value and a new estimated rear force value, from new transverse acceleration and yaw rate measurements, and from current values of estimated front force and estimated rear force, and by actualization and correction of intermediary values of front and rear forces, consisting in:
applying to the current values of estimated front force and estimated rear force a processing treatment based on the dynamic model to determine new values of estimated transverse acceleration and estimated yaw rate;
determining a first discrepancy value corresponding to the difference between the new measurement of transverse acceleration and the new estimated transverse acceleration, and a second discrepancy value corresponding to the difference between the new measurement of yaw rate and the new estimated yaw rate;
determining a new value of front intermediary force value by adding to the current value of front intermediary force a value proportional to the first discrepancy, and a new value of rear intermediary force by adding to the current value of rear intermediary force another value proportional to the first discrepancy;
determining the new values of estimated front force and estimated rear force by applying to the new values of front and rear intermediary forces a correcting processing operation consisting in adding to the new value of front intermediary force a value proportional to the second discrepancy and in subtracting from the new value of rear intermediary force a value proportional to the second discrepancy.

The invention also concerns a method for estimating, in a vehicle and in real time, a transverse force applied by the ground to each wheel, consisting in:
equipping this vehicle with load force measuring devices adapted to supply signals representative of the load force to which each wheel is subjected;
determining an estimated front force and an estimated rear force in accordance with claim 1;
determining in the processing unit the transverse force applied to the right front wheel and to the left front wheel as being proportional to the load of the right front wheel and to the load of the left front wheel, respectively, and having a sum corresponding to the estimated front force;
determining in the processing unit the transverse force applied to the right rear wheel and to the left rear wheel as being proportional to the load of the right rear wheel and to the load of the left rear wheel, respectively, and having a sum corresponding to the estimated rear force.

As a variant, the invention also concerns a method for estimating, in a vehicle and in real time, a transverse force applied by the ground to each wheel, consisting in:
equipping this vehicle with a load force estimating device adapted to supply estimated signals representative of the load force to which each wheel is subjected;
determining an estimated front force and an estimated rear force in accordance with claim 1;
determining in the processing unit the transverse force applied to the right front wheel and to the left front wheel as being proportional to the load of the right front wheel and to the load of the left front wheel, respectively, and having a sum corresponding to the estimated front force;
determining in the processing unit the transverse force applied to the right rear wheel and to the left rear wheel as being proportional to the load of the right rear wheel and to the load of the left rear wheel, respectively, and having a sum corresponding to the estimated rear force;

According to a first characteristic, the above-defined method consists in:
equipping this vehicle with a measuring device supplying a signal representative of the measured longitudinal acceleration; and
applying this signal and the transverse acceleration to the input of the estimating device to supply estimated signals representative of the load force to which each wheel is subjected.

According to this first characteristic, the estimation device implements the following equations:

$$* {F}_{zLFe} = \frac{mgb}{2 E} + \frac{mh {γ}_{x}}{E} - \frac{mh {γ}_{t}}{v} , \\ * {F}_{zRFe} = \frac{mgb}{2 E} - \frac{mh {γ}_{x}}{E} + \frac{mh {γ}_{t}}{v} , \\ * {F}_{zLRe} = \frac{mga}{2 E} + \frac{mh {γ}_{x}}{E} - \frac{mh {γ}_{t}}{v} , \\ * {F}_{zRRe} = \frac{mga}{2 E} - \frac{mh {γ}_{x}}{E} + \frac{mh {γ}_{t}}{v} .$$

with

a and b, the front and rear wheel bases, respectively,

E=a+b is the total wheel base,

v is half the distance between the left and right wheels of the vehicle,

h: height of the center of gravity G of the vehicle with respect to the ground,

m: mass of the vehicle,

g: acceleration of gravity,

γₓ and γ_{T}: longitudinal and transversal accelerations, respectively, of the vehicle considered at the center of gravity G

According to another characteristic of this variant, the method consists in:
equipping the vehicle with a group of measuring devices supplying signals representative of the vehicle velocity, of the roll rate, of the pitch rate, of the longitudinal velocity, of the vertical velocity, and of the displacements of the wheels with respect to the body; and
applying these signals, the yaw rate, and the transverse acceleration to the input of an estimating device.

According to this other characteristic, the estimating device comprises a mechanical model of the vehicle receiving as a first series of inputs, the longitudinal velocity, the longitudinal and transverse accelerations, the yaw rate, the vertical velocity, the roll rate, and the pitch rate, respectively, and receiving as a second series of inputs, the estimated vertical forces applied by the ground to the pneumatic tires of the left front wheel, right front wheel, left rear wheel, and right rear wheel, respectively ; these forces corresponding to the outputs of determined transfer functions specific to each wheel, respectively, these transfer functions receiving at their respective inputs, the discrepancy between the wheel displacements measured by measuring devices adapted to supply signals representative of said displacements, respectively, and the displacements of the wheels estimated by the model.

The invention will now be described in more details, and in reference to the annexed drawings which illustrate an embodiment thereof by way of a non-limitative example.

FIG. 1 illustrates the decomposition of the forces applied by the ground to a motor vehicle wheel;

FIG. 2 is a schematic view of a mechanical model of the bicycle type;

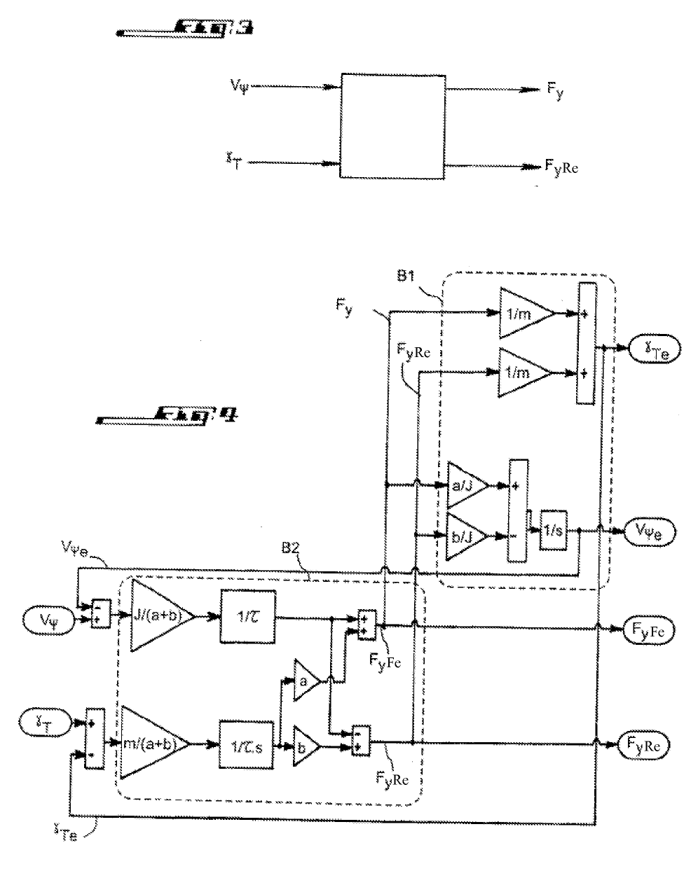

FIG. 3 is a block diagram illustrating the inputs and outputs in the method according to the invention;

FIG. 4 is a view in the form of a block diagram of the method according to the invention;

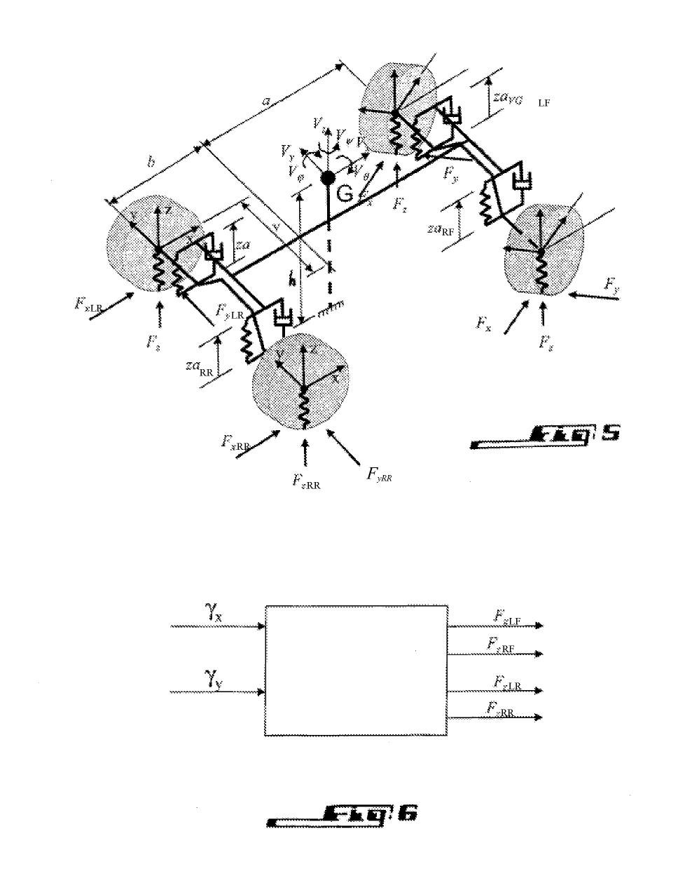

FIG. 5 is a schematic view of a dynamic mechanical model of a motor vehicle with four wheels;

FIG. 6 is a view in the form of a block diagram of a device for static estimation of the vertical forces;

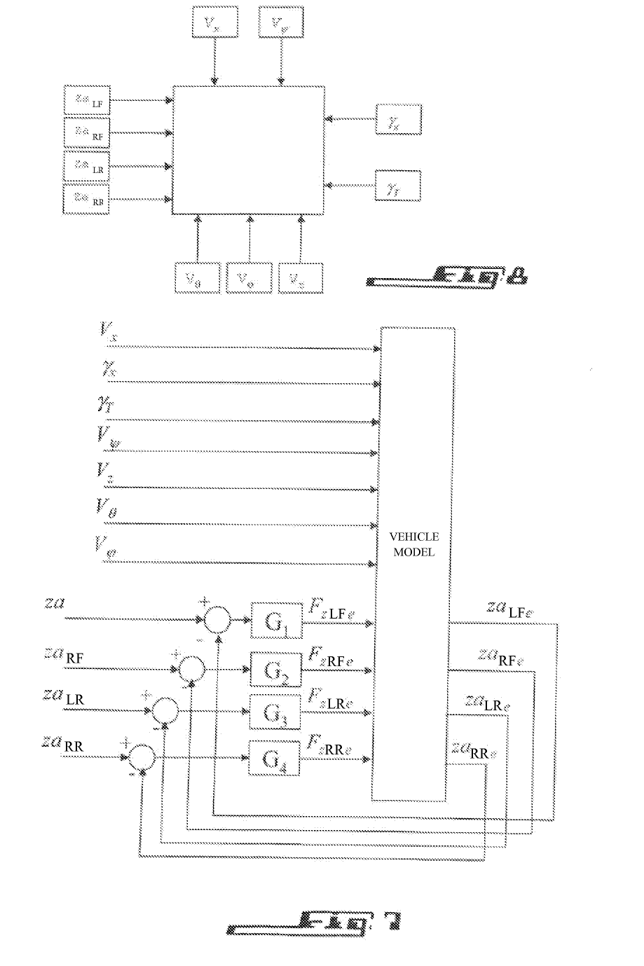

FIG. 7 is a view in the form of a block diagram of a device for dynamic estimation of the vertical forces; and

FIG. 8 is a block diagram representative of the processing unit of the signals stemming from the various sensors or estimators.

The invention concerns a closed-loop method for estimating in real time the inputs of a system which is a motor vehicle, the estimated inputs being the front and rear transverse forces.

The closed-loop estimation methods, also known under the name “observer,” make it possible to estimate state variables such as the position, the angle, the velocity, the acceleration, by using a dynamic mechanical model driven by a feedback loop depending on the estimation error.

The method according to the invention applies to a modeled physical system under the following form:

$$\{ \begin{matrix}\dot{X} ( t ) = A X ( t ) + BU ( t ) \\ Y ( t ) = CX ( t )\end{matrix} \qquad [ 1 ]$$

in which:

t: time

X: state variables;

U: input/control variables;

Y: output/measurement variables;

The variables X, U, and Y are vectors, having dimensions m, n, and p, respectively. A, B, and C are constant matrices representative of the physical system under consideration.

The idea at the basis of the invention is to estimate the components of the vector U, whose estimation is noted Uₑ, while the transfer function connecting the input of the system to its output is designated by T(s). Thus, we have:

$$T ( s ) = \frac{Y ( s )}{U ( s )} = {C ( sI - A )}^{- 1} B \qquad [ 2 ]$$

in which s is the Laplace variable, and I is the identity matrix.

By noting

$${G}_{d} ( s ) = \frac{{U}_{e} ( s )}{U ( s )}$$

the transfer function that it is desired to have between the input to be estimated U and the estimated input Ue, the estimation of the input is given by the equation Uₑ(s)=L(s)(Y(s)−Yₑ(s)) in which L is a gain matrix defined by the transfer function L(s)=G_{d}(s)(I−G_{d}(s))^{31 1}T⁻¹(s),

Yₑ(s) is the estimation of the measurements, obtained by the following equation:

$$\{ \begin{matrix}{\dot{X}}_{e} ( t ) = A {X}_{e} ( t ) + BL ( t ) ( Y ( t ) - {Y}_{e} ( t ) ) \\ {Y}_{e} ( t ) = {CX}_{e} ( t )\end{matrix} . \qquad [ 3 ]$$

Then, Ue tends towards U, i.e., lim_{t→∞}∥U(t)−Uₑ(t)∥=0 in an asymptotic manner, when various conditions are verified, i.e., the fact that the matrix T is reversible, that Gd is adapted to make L causal, and that the matrices A, B, and C are sufficiently full.

According to the invention, the estimation of the transverse forces is performed by applying to the vehicle a simplified dynamic mechanical model, such as a model of the tireless bicycle type, like the one that is shown schematically on FIG. 2. The implementation of a tireless bicycle model is indeed sufficient to determine the front F_{yF} and rear F_{yR} transverse force, given that the forces at each wheel can be deducted therefrom because they are proportional to the loads of these wheels.

The front transverse force F_{yF} is applied by the ground to the front wheel of the bicycle model, it corresponds to the sum of the transverse forces applied to the two front wheels of the vehicle. In an analogous manner, the rear transverse force F_{yR} corresponds to the sum of the forces applied to the rear wheels of the vehicle.

As shown schematically on FIG. 2, this dynamic model of the tireless bicycle type is defined by a mass m, a yawing moment noted J, a front wheel base and a rear wheel base noted a and b, respectively. The front and rear wheel bases correspond to the distance separating longitudinally the front wheels from the center of gravity of the vehicle, and to the distance separating longitudinally the rear wheels from this center of gravity, respectively. The vehicle is equipped with a measuring device located in the vicinity of the center of gravity, and delivering a signal representative of the longitudinal acceleration and a signal representative of the yaw rate.

The vehicle moves longitudinally at a velocity noted Vₓ, it has a transverse velocity noted V_{y}, it is moving with a velocity called yaw rate, noted V_{ψ} and corresponding to its rotation speed about a vertical axis.

The equations of the vehicle according to the tireless bicycle dynamic model are given below:

$$\dot{X} = [ \begin{matrix}0 & {V}_{x} \\ 0 & 0\end{matrix} ] [ \begin{matrix}{V}_{y} \\ {V}_{ψ}\end{matrix} ] + [ \begin{matrix}1 / m & 1 / m \\ a / J & - b / J\end{matrix} ] [ \begin{matrix}{F}_{y F} \\ {F}_{y R}\end{matrix} ] \\ \dot{X} = [ \begin{matrix}{\dot{V}}_{y} \\ {\dot{V}}_{ψ}\end{matrix} ] = AX + BU \qquad [ 4 ]$$

The transverse velocity is not measured directly, but measurements of the yaw rate V₁₀₄ and of the transverse acceleration γₜ=\dot{V}_{y}−VₓV_{ψ} are available, these measurements stemming from one or several devices including, for example, two dedicated acceleration sensors.

This makes it possible to rewrite the model as follows:

$$\{ \begin{matrix}{γ}_{t} = \frac{1}{m} {F}_{yF} + \frac{1}{m} {F}_{y R} \\ {\dot{V}}_{ψ} = \frac{a}{J} {F}_{yF} - \frac{b}{J} {F}_{yR}\end{matrix} and Y = [ \begin{matrix}{γ}_{t} \\ {V}_{ψ}\end{matrix} ]$$

The matrix connecting

$$[ \begin{matrix}{F}_{y F} \\ {F}_{yR}\end{matrix} ] to [ \begin{matrix}{γ}_{t} \\ {V}_{ψ}\end{matrix} ]$$

is then:

$$T ( s ) = [ \begin{matrix}1 / m & 1 / m \\ a / J & - b / J\end{matrix} ] .$$

The transfer function G_{d}(s) connecting the input to be estimated U and the estimated input Ue can be chosen as being

$${G}_{d} ( s ) = \frac{1}{1 + τ s} ,$$

given that the choice of this transfer function is free. τ is a time constant, i.e., representative of the reaction time of the system, and its value is, for example, 1/100^{th} of a second.

The estimated input Ue is then given by the following expression:

$$\begin{matrix}{U}_{e} ( s ) = L ( s ) ( Y ( s ) - {Y}_{e} ( s ) ) \\ = \frac{1}{τ s} [ \begin{matrix}\frac{bm}{( a + b )} & \frac{Js}{( a + b )} \\ \frac{am}{( a + b )} & \frac{- Js}{( a + b )}\end{matrix} ] ( Y ( s ) - {Y}_{e} ( s ) )\end{matrix} \qquad [ 6 ]$$

in which

$${Y}_{e} = [ \begin{matrix}{γ}_{ie} \\ {V}_{ψ e}\end{matrix} ] = [ \begin{matrix}1 & 0 \\ 0 & 1 / s\end{matrix} ] [ \begin{matrix}1 / m & 1 / m \\ a / J & - b / J\end{matrix} ] {U}_{e} ( s ) \qquad [ 7 ]$$

As illustrated by FIG. 3, the method according to the invention makes it possible to determine, from values of transverse acceleration and yaw rate, the front transverse force and the rear transverse force.

The method is also shown on FIG. 4, which corresponds in particular to a representation under Matlab/simulink. This Figure shows more particularly the processing operation that is implemented in a processing unit with which the vehicle is equipped.

This processing unit is connected in particular to one or several measuring devices supplying a signal representative of the transverse acceleration γ_{T} and a signal representative of the yaw rate V_{ψ}.

This processing operation implements a dynamic model, represented by the block B1, which is exploited by feedback to a regulator represented by the block B2. The regulator B2 receives as input discrepancies between measured and estimated values of transverse acceleration and yaw rate, and it supplies as output the front force and the rear force. The dynamic model of the block B1 receives as input the output of the regulator to supply as output an estimated transverse acceleration and an estimated yaw rate, which are injected into the discrepancies applied at the input of the regulator B2.

More particularly, the dynamic mechanical model of the tireless bicycle type, represented by the block B1, receives as input values or signals representative of the estimated front transverse force F_{yFe} and of the estimated rear transverse force F_{yRe} to supply as output values or signals representative of an estimated transverse acceleration γ_{Te} and of an estimated yaw rate V_{ψe}.

As shown schematically in the block B1, the yaw rate is determined by integration of the moment of the front force F_{yFe} and of the rear force F_{yRe} about a vertical axis coinciding with the measuring device. The transverse acceleration γ_{Te}, for its part, results from the sum of the front and rear forces divided by the mass of the vehicle.

The regulator represented by the block B2 receives as input a first discrepancy signal and a second discrepancy signal to supply as output signals representative of the estimated front force F_{yFe} and of the estimated rear force F_{yRe}.

The first discrepancy is representative of the difference between the measured acceleration γ_{T}, i.e., stemming from the measuring device, and the estimated acceleration γ_{Te} resulting from the dynamic model, i.e., stemming from the block B1.

The second discrepancy is representative of the difference between the measured yaw rate V₁₀₄ , i.e., stemming from the measuring device, and the estimated yaw rate V₁₀₄ , i.e., stemming from the dynamic model of the block B1.

As shown schematically in the block B2, the first discrepancy and the second discrepancy applied as input of the regulator B2 are processed by performing a processing operation of the proportional and/or integral type to generate as output signals or values representative of the estimated front force F_{yFe} and of the estimated rear force F_{yRe}.

More particularly, the signal representative of the front transverse force F_{yFe} is obtained by applying a proportional integral processing operation to the first discrepancy, by applying a proportional processing operation to the second discrepancy, and by combination of the thus generated signals.

The signal representative of the rear transverse force F_{yRe} is obtained in an analogous manner, but with different coefficients in this for each proportional processing operation, these coefficients being in particular conditioned by the values of the wheel bases.

The combination of the signals generated by the proportional and integral, and proportional, respectively, processing operations applied to the first discrepancy and to the second discrepancy can be a linear combination, as in the example of FIG. 4, but it can also be any other combination, which is not necessarily linear.

Thus, the regulator B2 modifies its outputs F_{yFe} and F_{yRe} on the basis of the discrepancies it receives as input, so as to reduce these discrepancies, which makes it possible to let the estimated values tend towards the actual values of the transverse forces.

In general, different regulators B2 can be implemented, for example, in the form of regulators of the proportional-integral-derivative type, or in the form of non-linear regulators.

The passage to discrete time leads to the following recurrent equations:

$$\begin{matrix}\{ \begin{matrix}{F}_{yFe} ( k ) = \frac{1}{τ} \frac{J}{a + b} ( {V}_{ψ} ( k ) - {V}_{ψ e} ( k ) ) + \frac{1}{τ} \frac{b \cdot m}{a + b} {V}_{ye} ( k ) \\ {F}_{yRe} ( k ) = \frac{1}{τ} \frac{J}{a + b} ( {V}_{ψ} ( k ) - {V}_{ψ e} ( k ) ) + \frac{1}{τ} \frac{a \cdot m}{a + b} {V}_{ye} ( k )\end{matrix} \\ with \text{:} & [ 8 ] \\ \{ \begin{matrix}{V}_{ye} ( k ) = {V}_{ye} ( k - 1 ) + T ( {γ}_{T} ( k ) - {γ}_{Te} ( k ) ) \\ {γ}_{Te} ( k ) = \frac{1}{m} ( {F}_{yFe} ( k - 1 ) + {F}_{yRe} ( k - 1 ) ) \\ {V}_{ψ e} ( k ) = {V}_{ψ e} ( k - 1 ) + T \frac{1}{J} ( {aF}_{yFe} ( k ) - {bF}_{yRe} ( k ) )\end{matrix} & [ 9 ]\end{matrix}$$

where T designates the time interval selected for the passage to discrete time, and is less than or equal to 1/1000^{th} of second.

These equations are initialized with V_{ψe}(0) at V_{ψ}(0), γ_{Te}(0) at γ_{T}(0), and V_{ye}(0) at 0. The values V_{ψ,(k-}1) and γ_{T}(k−1) are the values of the yaw rate and of the transverse acceleration, respectively, measured at the instant t(k−1), i.e., at the instant t=T. (k−1).

The application of the method in a discrete time can thus be implemented in a processing unit including, for example, a microcontroller or a microprocessor adapted to perform, in real time, the algebraic operations that make it possible to determine the terms of the equations [8] and [9].

For the implementation discretized in real time, it is possible to introduce additional variables: ε_{iγ} which is the integral of the estimation error on the transverse acceleration, and ε_{Vψ}which is the estimation error on the yaw rate.

The variables are initialized with F_{yFe}(0)=0, F_{yFe}(0)=0, F_{yRe}(0)=0, ε_{iγe}(0)=0 and V_{ψe}(0)=V_{ψ}(0).

At each instant t(k), i.e., T.k, the measurement values are recovered, with γ_{T}(k)=)γ_{T}(kT), and V_{ψ}(k)=γ_{ψ}(kT). Estimated values of these measurements, noted γ_{Te}(k) and V_{ψe}(k), are then calculated from the transverse forces determined at the preceding instant t(k−1), with the following relationships:

$${γ}_{Te} ( k ) = \frac{1}{m} ( {F}_{yFe} ( k - 1 ) + {F}_{yRe} ( k - 1 ) ) \\ {V}_{ψ e} ( k ) = {V}_{ψ e} ( k - 1 ) + \frac{T}{J} ( {aF}_{yFe} ( k - 1 ) - {bF}_{yRe} ( k - 1 ) ) \qquad [ 10 ]$$

These relationships result from the system of equations [5], the expression of V_{ψe}(k) being obtained by integration of the second line of the system of equations [5]. The additional variables, noted ε_{iγ} and ε_{Vψ}, are calculated according to the following relationships:
ε_{iγ}(k)=ε_{iγ}(k−1)+T(γ_{T}(k)−γ_{Te}(k)) and ε_{V}_{_{ψ}}(k)=V_{ψ}(k)−V_{ψe}(k). [11]

The transverse forces for the instant t(k) are then determined according to the following relationships:

$${F}_{yFe} ( k ) = \frac{1}{τ} \frac{bm}{a + b} {ɛ}_{i γ} ( k ) + \frac{1}{τ} \frac{J}{a + b} {ɛ}_{F γ} ( k ) \\ {F}_{yRe} ( k ) = \frac{1}{τ} \frac{am}{a + b} {ɛ}_{i γ} ( k ) - \frac{1}{τ} \frac{J}{a + b} {ɛ}_{F ψ} ( k ) \qquad [ 12 ]$$

The process is then reiterated at the following instant t(k+1).

The magnitudes

$$\frac{1}{τ} \frac{bm}{a + b} {ɛ}_{i γ} ( k ) and \frac{1}{τ} \frac{am}{a + b} {ɛ}_{i γ} ( k )$$

constitute a front intermediary force and a rear intermediary force, respectively, these values being actualized at each iteration.

Taking into account the equations [11], the actualization of a current value of front intermediary force

$$\frac{1}{τ} \frac{bm}{a + b} {ɛ}_{i γ} ( k - 1 )$$

consists simply in adding a value proportional to the first discrepancy, i.e.,

$$\frac{1}{τ} \frac{bm}{a + b} ⊤ ( {γ}_{T} ( k ) - {γ}_{Te} ( k ) )$$

to obtain a new value of front intermediary force. The actualization of a current value of rear intermediary force is performed in a similar manner.

The determination of the estimated front and rear forces then simply consists in correcting the values of front and rear intermediary forces, by addition and by subtraction, respectively, of a corrective value which is proportional to the second discrepancy, this corrective value being

$$\frac{1}{τ} \frac{J}{a + b} {ɛ}_{V ψ} ( k ) .$$

Thus, the invention offers a very simple method of evaluating the front transverse force and the rear transverse force which is based only on a measurement of transverse acceleration and a measurement of yaw rate.

The transverse acceleration and the yaw rate are, for example, coming from a dedicated measuring device including two accelerometers spaced apart from each other longitudinally with respect to the vehicle, these sensors making it possible to know the transverse acceleration to which the vehicle is subjected, and which results from the average of the values stemming from the two accelerometers.

The yaw rate results from the integration of the moment generated by the accelerations collected at these two accelerometers, about a vertical axis.

Thus, this method makes it possible to estimate the front and rear transverse forces without the need to use any elaborated specific model. In particular, it is not necessary to model the tires of the vehicle to evaluate the transverse forces.

Indeed, the standard bicycle model uses a model of tires which is linear. The standard bicycle model is then valid only up to a maximal transverse acceleration of 4 m/s2.

The method according to the invention does not use any tire model but it does not require a linear behavior of the tire either, so that the range of validity is not limited to transverse acceleration up to 4 m/s².

The method according to the invention makes it possible to perform the evaluation of the front and rear force without the need to derive signals, but, on the contrary, by performing only integration operations. This method makes it thus possible to avoid the high risks that the implementation of signal derivation operations would induce.

An estimation of the transverse forces for each wheel can be determined from an estimation of the vertical loads of each wheel, resulting from a measurement or another. Indeed, the transverse force applied by the ground to a wheel is proportional to its vertical load. The transverse forces for each wheel can thus be determined from the equalities below:

$${F}_{yLF} = \frac{{F}_{zLF}}{{F}_{zLF} + {F}_{zRF}} {F}_{yF}$$

in which:
F_{zLF}: vertical load Left Front wheel

$${F}_{y RF} = \frac{{F}_{zRF}}{{F}_{zLF} + {F}_{zRF}} {F}_{yF}$$

F_{zRF}: vertical load Right Front wheel
F_{zLR}: vertical load Left Rear wheel

$${F}_{y LR} = \frac{{F}_{zLR}}{{F}_{zLR} + {F}_{zRR}} {F}_{yR}$$

F_{zRR}: vertical load Right Rear wheel

$${F}_{y RR} = \frac{{F}_{zRR}}{{F}_{zLR} + {F}_{zRR}} {F}_{yR}$$

F_{yLF}: transverse force Left Front wheel
F_{yRF}: transverse force Right Front wheel
F_{yLR}: transverse force Left Rear wheel
F_{yRR}: transverse force Right Rear wheel

Just like the measurement of the transverse forces, it is not possible to measure the vertical forces in real time in a direct manner at a cost compatible with mass production.

To remedy this drawback, the present invention proposes two estimation methods to estimate the vertical forces: a first, open-loop method, called static method, which is valid for constant longitudinal and transverse accelerations, and a second, closed-loop estimation, called dynamic estimation, which takes into account the dynamic properties of the vehicle.

Before describing these two methods, the various variables and parameters representative of physical magnitudes that will be used in reference to FIG. 5 are defined below, FIG. 5 representing schematically a dynamic mechanical model of a four-wheel motor vehicle,.

The following physical magnitudes will thus be noted by:

Vₓ, V_{y} and V_{z}, the longitudinal, transverse, and vertical velocities, respectively;

V_{θ}, V_{φ}, and V_{ψ}, the roll, pitch, and yaw rates, respectively;

F_{xLF}, F_{xRF}, F_{xLR}, and F_{xRR}, the longitudinal forces applied by the ground to the left front, right front, left rear, and right rear pneumatic tires, respectively;

F_{yLF}, F_{yRP}, F_{yLR}, and F_{yRR}, the transverse forces applied by the ground to the left front, right front, left rear, and right rear pneumatic tires, respectively;

F_{zLF}, F_{zRF}, F_{zLR}, and F_{zRR}, the vertical forces (load at the wheel) applied by the ground to the left front, right front, left rear, and right rear pneumatic tires, respectively;

Za_{LF}, Za_{RF}, Za_{LR}, and Za_{RR}, the displacements of the left front, right front, left rear, and right rear wheels, respectively, with respect to the body (distance between the wheel center and the upper attachment point of the suspension to the body);

a and b, the front and rear wheel bases, respectively,

E=a+b is the total wheel base,

v is half the distance between left and right wheels of the vehicle, and

h: height of the center of gravity G

The following will also be noted:

m: mass of the vehicle,

I_{θ}, I_{φ}, and I_{ψ}, the rolling, pitching, and yawing moments, respectively,

g: the acceleration of gravity,

γₓ and γ_{T}: the longitudinal and transverse accelerations, respectively, of the vehicle, considered at the center of gravity G.

In the following, these same notations will be used to designate the signals representative of these magnitudes, respectively; signals stemming from measuring devices such as sensors or estimators.

To implement these methods, the vehicle is equipped with a device for estimating the load forces adapted to supply signals representative of the load force to which each wheel F_{zLF}, F_{zRF}, F_{zLR}, and F_{zRR} is subjected.

As illustrated on FIG. 6, the first, so-called static, estimation method makes it possible to determine, from the longitudinal and transverse accelerations of the vehicle γₓ and γ_{T}, considered at the center of gravity G of the vehicle, the vertical forces F_{zLF}, F_{zRF}, F_{zLR and F}_{zRR} (load at the wheel) applied to the left front, right front, left rear, and right rear pneumatic tires, respectively.

In this first method, the vehicle is equipped with a measuring device supplying a signal representative of the measured longitudinal acceleration γₓ and this signal γₓ and the transverse acceleration γ_{T}, already available, are applied to the input of an estimator to supply estimated signals representative of the load force F_{zLFe}, F_{zRFe}, F_{zLRe}, F_{RRe}, respectively, to which each wheel is subjected.

The estimated vertical forces F_{zLFe}, F_{zRFe}, F_{LRe}, F_{zRRe} are then calculated from the following equations:

$${F}_{zLFe} = \frac{mgb}{2 E} + \frac{mh {γ}_{x}}{E} - \frac{mh {γ}_{t}}{v} , \\ {F}_{zRFe} = \frac{mgb}{2 E} - \frac{mh {γ}_{x}}{E} + \frac{mh {γ}_{t}}{v} , \\ {F}_{zLRe} = \frac{mga}{2 E} + \frac{mh {γ}_{x}}{E} - \frac{mh {γ}_{t}}{v} , and$$

$${F}_{zRRe} = \frac{mga}{2 E} - \frac{mh {γ}_{x}}{E} + \frac{mh {γ}_{t}}{v} .$$

The second, so-called dynamic, estimation method, is illustrated by the block diagram of FIG. 7.

The dynamic estimation in closed loop uses the same methodology as for the previously described estimation of the transverse forces.

This methodology is thus applied again, and it will thus not be described.

For this second method, the estimating device comprises a mechanical model of the vehicle, conform to that described on FIG. 5, receiving as a first series of inputs the longitudinal velocity Vₓ, the longitudinal and transverse accelerations γₓ et γ_{T}, the yaw rate V_{ψ}, the vertical velocity V_{z}, the roll rate V_{θ}, and the pitch rate V_{φ}. respectively. It receives, as a second series of inputs, the estimated vertical forces F_{zLFe}, F_{zRFe}, F_{zLRe}, F_{zRRe} applied by the ground to the pneumatic tires of the front left, front right, rear left, and rear right wheels, respectively. These forces F_{zLFe}, F_{zRFe}, F_{zLRe}, F_{zRRe} correspond to the outputs of determined transfer functions G1 to G4 specific to each wheel, respectively. These transfer functions G1 to G4 receive at their respective inputs the discrepancy between the displacements of the wheels Za_{LF}, Za_{RF}, Za_{LR}, and Za_{RR} measured by measuring devices adapted to supply signals representative of said displacements, respectively, and the displacements of the wheels Za_{LFe}, Za_{RFe}, Za_{LRe}, and Za_{RRe} estimated by the model.

FIG. 8 shows, with a block diagram, the processing unit, for example, integrated in an on-board computer of the vehicle.

This processing unit receives and processes the various measurements from the various above-mentioned measuring devices while being adapted to implement the various above-mentioned estimation methods.

The number and the choice of the measuring devices coupled to the processing unit depend on the method used.

Thus, for the method applying the bicycle model, two measuring devices are used: a device for measuring the yaw rate V_{ψ}and a device for measuring the transverse acceleration γ_{T}.

For the so-called static method applying the dynamic mechanical model of the vehicle, another measuring device is used in addition to the two previous ones: a device for measuring the longitudinal acceleration γₓ.

For the so-called dynamic method applying the dynamic mechanical model of the vehicle, eight other measuring devices are used: devices for measuring the displacements of the four wheels Za_{LF}, Za_{RF}, Za_{LR}, and Za_{RR}, respectively, a device for measuring the longitudinal velocity Vₓ, a device for measuring the vertical velocity V_{z}, a device for measuring the roll rate V_{θ}, and a device for measuring the pitch rate V_{φ}.

The velocity and acceleration measuring devices can be grouped together within a same inertial unit, disposed at the center of gravity G of the vehicle, and coupled to a navigation system of the GPS (Global Positioning System) type.

1. Method for estimating in real time, in a motor vehicle, a front force (F_{yFe}) and a rear force (F_{yRe}), these forces being applied by the ground to the front wheels and to the rear wheels, respectively, of the vehicle along a transverse direction, this method consisting in:
equipping this vehicle with a measuring device supplying a signal representative of a measured transverse acceleration (γ_{T}) and a signal representative of a measured yaw rate (V_{ψ}), and with a processing unit;
applying to these signals, in the processing unit, a processing operation to determine a front force and a rear force based on a dynamic model of the vehicle such as a model of the tireless bicycle type defined in particular by a front wheel base (a) a rear wheel base (b), a mass (m), and a yawing moment (J), to supply a signal representative of the estimated front force (F_{yFe}) and of the estimated rear force (F_{yRe}).

2. Method according to claim 1, in which the processing operation includes a feedback loop, and implements a dynamic model that makes it possible to determine a transverse acceleration and a yaw rate from a front force and a rear force, and consists in:
applying to the signals representative of the estimated front force (F_{yFe}) and of the estimated rear force (F_{yRe}) a processing operation based on the dynamic model to form a signal representative of an estimated transverse acceleration (γ_{Te}) and a signal representative of an estimated yaw rate (V_{ψe});
forming a first discrepancy signal representative of the difference between the measured (γ_{T}) and estimated (γ_{Te}) transverse accelerations, and a second discrepancy signal representative of the difference between the measured (V_{ψ}) and estimated (V_{ψe}) yaw rates;
forming the signal representative of the front force (F_{yFe}) by combination of a signal stemming from a processing operation such as a proportional and/or integral processing operation applied to the first discrepancy signal, with a signal stemming from a processing operation such as a proportional and/or integral processing operation applied to the second discrepancy signal;
forming the signal representative of the rear force (F_{yRe}) by combination of a signal stemming from a processing operation such as a proportional and/or integral processing operation applied to the first discrepancy signal, with a signal stemming from a processing operation such as a proportional and/or integral processing operation applied to a second discrepancy signal.

3. Method according to claim 1, wherein:
the signal representative of the front force (F_{yFe}) is obtained by a linear combination of a signal stemming from a proportional processing operation applied to the first discrepancy signal, with a signal stemming from a proportional and integral processing operation applied to the second discrepancy signal;
the signal representative of the rear force (F_{yRe}) is obtained by another linear combination of a signal stemming from a proportional processing operation applied to the first discrepancy signal, with a signal stemming from a proportional and integral processing operation applied to the second discrepancy signal.

4. Method according to claim 1, discretized, consisting in determining a new estimated front force value (F_{yFe}(k)) and a new estimated rear force value (F_{yRe}(k)), from new transverse acceleration (γ_{T}(k)) and yaw rate (V_{ψ}(k)) measurements, and from current values of estimated front force (F_{yFe}(k−1)) and estimated rear force (F_{yRe}(k−1)), and by actualization and correction of intermediary values of front and rear forces, consisting in:
applying to the current values of estimated front force (F_{yFe}(k−1)) and estimated rear force (F_{yRe}(k−1)) a processing treatment based on the dynamic model to determine new values of estimated transverse acceleration (γ_{Te}(k)) and estimated yaw rate (V_{ψe}(k));
determining a first discrepancy value corresponding to the difference between the new measurement of transverse acceleration (γ_{T}(k)) and the new estimated transverse acceleration (γ_{Te}(k)), and a second discrepancy value corresponding to the difference between the new measurement of yaw rate (V_{ψ}(k)) and the new estimated yaw rate (V_{ψe}(k));
determining a new value of front intermediary force value
$$( \frac{1}{τ} \frac{bm}{a + b} {ɛ}_{i γ} ( k ) )$$
by adding to the current value of front intermediary force
$$( \frac{1}{τ} \frac{bm}{a + b} {ɛ}_{i γ} ( k - 1 ) )$$
a value proportional to the first discrepancy
$$( \frac{1}{τ} \frac{bm}{a + b} T ( {γ}_{T} ( k ) - {γ}_{Te} ( k ) ) ) ,$$
and a new value of rear intermediary force
$$( \frac{1}{τ} \frac{am}{a + b} {ɛ}_{i γ} ( k ) )$$
by adding to the current value of rear intermediary force
$$( \frac{1}{τ} \frac{am}{a + b} {ɛ}_{i γ} ( k - 1 ) )$$
another value proportional to the first discrepancy
$$( \frac{1}{τ} \frac{am}{a + b} T ( {γ}_{T} ( k ) - {γ}_{Te} ( k ) ) ) ;$$
determining the new values of estimated front force (F_{yFe}(k)) and estimated rear force (F_{yRe}(k)) by applying to the new values of front and rear intermediary forces a correcting processing operation consisting in adding to the new value of front intermediary force
$$( \frac{1}{τ} \frac{bm}{a + b} {ɛ}_{i γ} ( k ) )$$
a value proportional to the second discrepancy
$$( \frac{1}{τ} \frac{J}{a + b} {ɛ}_{V ψ} ( k ) )$$
and in subtracting from the new value of rear intermediary force
$$( \frac{1}{τ} \frac{am}{a + b} {ɛ}_{i γ} ( k ) )$$
a value proportional to the second discrepancy
$$( \frac{1}{τ} \frac{J}{a + b} {ɛ}_{V ψ} ( k ) ) .$$

5. Method for estimating, in a vehicle and in real time, a transverse force (F_{yLF}, F_{yRF}, F_{yLR}, F_{yRR}) applied by the ground to each wheel, consisting in:
equipping this vehicle with load force measuring devices adapted to supply signals representative of the load force (F_{zLF}, F_{zRF}, F_{zRR}) to which each wheel is subjected;
determining an estimated front force (F_{yFe}) and an estimated rear force (F_{yRe}) in accordance with claim 1;
determining in the processing unit the transverse force applied to the right front wheel (F_{yLF}) and to the left front wheel (F_{zLF}) as being proportional to the load of the right front wheel (F_{zRF}) and to the load of the left front wheel (F_{zLF}), respectively, and having a sum corresponding to the estimated front force (F_{yFe});
determining in the processing unit the transverse force applied to the right rear wheel (F_{yRR}) and to the left rear wheel (F_{yLR}) as being proportional to the load of the right rear wheel (F_{zRR}) and to the load of the left rear wheel (F_{zLR}), respectively, and having a sum corresponding to the estimated rear force (F_{yRe}).

6. Method for estimating, in a vehicle and in real time, a transverse force (F_{yLF}, F_{yRF}, F_{yLR}, F_{yRR}) applied by the ground to each wheel, consisting in:
equipping this vehicle with a load force estimating device adapted to supply estimated signals representative of the load force (F_{zLFe}, F_{zRFe}, F_{zLRe}, F_{zyRR}) to which each wheel is subjected;
determining an estimated front force (F_{yFe}) and an estimated rear force (F_{yRe},) in accordance with claim 1;
determining in the processing unit the transverse force applied to the right front wheel (F_{yRF}) and to the left front wheel (F_{yLF}) as being proportional to the load of the right front wheel (F_{zRF}) and to the load of the left front wheel (F_{zLF}), respectively, and having a sum corresponding to the estimated front force (F_{yFe});
determining in the processing unit the transverse force applied to the right rear wheel (F_{yRR}) and to the left rear wheel (F_{yLR}) as being proportional to the load of the right rear wheel (F_{zRR}) and to the load of the left rear wheel (F_{zLR}), respectively, and having a sum corresponding to the estimated rear force (F_{yRe}).

7. Method according to claim 6, consisting in:
equipping this vehicle with a measuring device supplying a signal representative of the measured longitudinal acceleration (γₓ); and
applying this signal (γₓ) and the transverse acceleration (γ_{T}) to the input of the estimating device to supply estimated signals representative of the load force (F_{LFe}, F_{zRFe}, F_{zLRe}, F_{zRRe}) to which each wheel is subjected.

8. Method according to claim 7, wherein the estimating device implements the following equations:
$$* {F}_{zLFe} = \frac{mgb}{2 E} + \frac{mh {γ}_{x}}{E} - \frac{mh {γ}_{t}}{v} , \\ * {F}_{zRFe} = \frac{mgb}{2 E} - \frac{mh {γ}_{x}}{E} + \frac{mh {γ}_{t}}{v} , \\ * {F}_{zLRe} = \frac{mga}{2 E} + \frac{mh {γ}_{x}}{E} - \frac{mh {γ}_{t}}{v} , \\ * {F}_{zRRe} = \frac{mga}{2 E} - \frac{mh {γ}_{x}}{E} + \frac{mh {γ}_{t}}{v} .$$
with
a and b, the front and rear wheel bases, respectively,
E=a+b is the total wheel base,
v is half the distance between the left and right wheels of the vehicle,
h: height of the center of gravity G of the vehicle with respect to the ground,
m: mass of the vehicle,
g: acceleration of gravity,
γₓ and γ_{T}: longitudinal and transversal accelerations, respectively, of the vehicle considered at the center of gravity G.

9. Method according to claim 6 consisting in
equipping the vehicle with a group of measuring devices supplying signals representative of the vehicle velocity (Vₓ), of the roll rate (V_{θ}), of the pitch rate (V_{φ}), of the longitudinal velocity (V_{θ}), of the vertical velocity (V_{z}), and of the displacements of the wheels with respect to the body (za_{LF}, za_{RF}, za_{LR}, za_{RR}); and
applying these signals, the yaw rate (V_{φ}), and the transverse acceleration (γ_{T}) to the input of an estimating device.

10. Method according to claim 9, characterized in that the estimating device comprises a mechanical model of the vehicle receiving as a first series of inputs, the longitudinal velocity (Vₓ), the longitudinal and transverse accelerations (γₓ and γ_{T}), the yaw rate (V_{ψ}), the vertical velocity (V_{z}), the roll rate (V_{θ}), and the pitch rate (V_{φ}), respectively, and receiving as a second series of inputs, the estimated vertical forces (F_{zLFe}, F_{zRFe}, F_{zLRe}, F_{zRRe}) applied by the ground to the pneumatic tires of the left front wheel, right front wheel, left rear wheel, and right rear wheel, respectively; these forces (F_{LFe}, F_{zRe}, F_{zLRe}, F_{zRRe}) corresponding to the outputs of determined transfer functions (G1 to G4) specific to each wheel, respectively, these transfer functions (G1 to G4) receiving at their respective inputs, the discrepancy between the wheel displacements (Za_{LF}, Za_{RF}, Za_{LR}, et Za_{RR}) measured by measuring devices adapted to supply signals representative of said displacements, respectively, and the displacements of the wheels (Za_{LFe}, Za_{RFe}, Za_{LRe}, et Za_{RRe}) estimated by the model.

11. Method according to claim 2, wherein:
the signal representative of the front force (F_{yFe}) is obtained by a linear combination of a signal stemming from a proportional processing operation applied to the first discrepancy signal, with a signal stemming from a proportional and integral processing operation applied to the second discrepancy signal;
the signal representative of the rear force (F_{yRe}) is obtained by another linear combination of a signal stemming from a proportional processing operation applied to the first discrepancy signal, with a signal stemming from a proportional and integral processing operation applied to the second discrepancy signal.

12. Method according to claim 2, discretized, consisting in determining a new estimated front force value (F_{yFe}(k)) and a new estimated rear force value (F_{yRe}(k)), from new transverse acceleration (γ_{T}(k)) and yaw rate (V_{ψ}(k)) measurements, and from current values of estimated front force (F_{yFe}(k−1)) and estimated rear force (F_{yRe}(k−1)), and by actualization and correction of intermediary values of front and rear forces, consisting in:
applying to the current values of estimated front force (F_{yFe}(k−1)) and estimated rear force (F_{yRe}(k−1)) a processing treatment based on the dynamic model to determine new values of estimated transverse acceleration (γ_{Te}(k)) and estimated yaw rate (V_{ψe}(k));
determining a first discrepancy value corresponding to the difference between the new measurement of transverse acceleration (γ_{T}(k)) and the new estimated transverse acceleration (γ_{Te}(k)), and a second discrepancy value corresponding to the difference between the new measurement of yaw rate (V_{ψ}(k)) and the new estimated yaw rate (V_{ψe}(k));
determining a new value of front intermediary force value
$$( \frac{1}{τ} \frac{bm}{a + b} {ɛ}_{i γ} ( k ) )$$
by adding to the current value of front intermediary force
$$( \frac{1}{τ} \frac{bm}{a + b} {ɛ}_{i γ} ( k - 1 ) )$$
a value proportional to the first discrepancy
$$( \frac{1}{τ} \frac{bm}{a + b} ⊤ ( {γ}_{T} ( k ) - {γ}_{Te} ( k ) ) ) ,$$
and a new value of rear intermediary force
$$( \frac{1}{τ} \frac{am}{a + b} {ɛ}_{i γ} ( k ) )$$
by adding to the current value of rear intermediary force
$$( \frac{1}{τ} \frac{am}{a + b} {ɛ}_{i γ} ( k - 1 ) )$$
another value proportional to the first discrepancy
$$( \frac{1}{τ} \frac{am}{a + b} ⊤ ( {γ}_{T} ( k ) - {γ}_{Te} ( k ) ) ) ;$$
determining the new values of estimated front force (F_{yFe}(k)) and estimated rear force (F_{yRe}(k)) by applying to the new values of front and rear intermediary forces a correcting processing operation consisting in adding to the new value of front intermediary force
$$( \frac{1}{τ} \frac{bm}{a + b} {ɛ}_{i γ} ( k ) )$$
a value proportional to the second discrepancy
$$( \frac{1}{τ} \frac{J}{a + b} {ɛ}_{V ψ} ( k ) )$$
and in subtracting from the new value of rear intermediary force
$$( \frac{1}{τ} \frac{am}{a + b} {ɛ}_{i γ} ( k ) )$$
a value proportional to the second discrepancy
$$( \frac{1}{τ} \frac{J}{a + b} {ɛ}_{V ψ} ( k ) ) .$$

13. Method according to claim 3, discretized, consisting in determining a new estimated front force value (F_{yFe}(k)) and a new estimated rear force value (F_{yRe}(k)), from new transverse acceleration (γ_{T}(k)) and yaw rate (V_{ψ}(k)) measurements, and from current values of estimated front force (F_{yFe}(k−1)) and estimated rear force (F_{yRe}(k−1)), and by actualization and correction of intermediary values of front and rear forces, consisting in:
applying to the current values of estimated front force (F_{yFe}(k−1)) and estimated rear force (F_{yRe}(k−1)) a processing treatment based on the dynamic model to determine new values of estimated transverse acceleration (γ_{Te}(k)) and estimated yaw rate (V_{ψe}(k));
determining a first discrepancy value corresponding to the difference between the new measurement of transverse acceleration (γ_{T}(k)) and the new estimated transverse acceleration (γ_{Te}(k)), and a second discrepancy value corresponding to the difference between the new measurement of yaw rate (V_{ψ}(k)) and the new estimated yaw rate (V_{ψe}(k));
determining a new value of front intermediary force value
$$( \frac{1}{τ} \frac{bm}{a + b} {ɛ}_{i γ} ( k ) )$$
by adding to the current value of front intermediary force
$$( \frac{1}{τ} \frac{bm}{a + b} {ɛ}_{i γ} ( k - 1 ) )$$
a value proportional to the first discrepancy
$$( \frac{1}{τ} \frac{bm}{a + b} ⊤ ( {γ}_{T} ( k ) - {γ}_{Te} ( k ) ) ) ,$$
and a new value of rear intermediary force
$$( \frac{1}{τ} \frac{am}{a + b} {ɛ}_{i γ} ( k ) )$$
by adding to the current value of rear intermediary force
$$( \frac{1}{τ} \frac{am}{a + b} {ɛ}_{i γ} ( k - 1 ) )$$
another value proportional to the first discrepancy
$$( \frac{1}{τ} \frac{am}{a + b} ⊤ ( {γ}_{T} ( k ) - {γ}_{Te} ( k ) ) ) ;$$
determining the new values of estimated front force (F_{yFe}(k)) and estimated rear force (F_{yRe}(k)) by applying to the new values of front and rear intermediary forces a correcting processing operation consisting in adding to the new value of front intermediary force
$$( \frac{1}{τ} \frac{bm}{a + b} {ɛ}_{i γ} ( k ) )$$
a value proportional to the second discrepancy
$$( \frac{1}{τ} \frac{J}{a + b} {ɛ}_{V ψ} ( k ) )$$
and in subtracting from the new value of rear intermediary force
$$( \frac{1}{τ} \frac{am}{a + b} {ɛ}_{i γ} ( k ) )$$
a value proportional to the second discrepancy
$$( \frac{1}{τ} \frac{J}{a + b} {ɛ}_{V ψ} ( k ) ) .$$

14. Method according to claim 11, discretized, consisting in determining a new estimated front force value (F_{yFe}(k)) and a new estimated rear force value (F_{yRe}(k)), from new transverse acceleration (γ_{T}(k)) and yaw rate V_{ψ}(k)) measurements, and from current values of estimated front force (F_{yFe}(k−1)) and estimated rear force (F_{yRe}(k−1)), and by actualization and correction of intermediary values of front and rear forces, consisting in:
applying to the current values of estimated front force (F_{yFe}(k−1)) and estimated rear force (F_{yRe}(k−1)) a processing treatment based on the dynamic model to determine new values of estimated transverse acceleration (γ_{Te}(k)) and estimated yaw rate (V_{ψe}(k) );
determining a first discrepancy value corresponding to the difference between the new measurement of transverse acceleration (γ_{T}(k)) and the new estimated transverse acceleration (γ_{Te}(k)), and a second discrepancy value corresponding to the difference between the new measurement of yaw rate V_{ψ}(k)) and the new estimated yaw rate (V_{ψe}(k));
determining a new value of front intermediary force value
$$( \frac{1}{τ} \frac{bm}{a + b} {ɛ}_{i γ} ( k ) )$$
by adding to the current value of front intermediary force
$$( \frac{1}{τ} \frac{bm}{a + b} {ɛ}_{i γ} ( k - 1 ) )$$
a value proportional to the first discrepancy
$$( \frac{1}{τ} \frac{bm}{a + b} ⊤ ( {γ}_{T} ( k ) - {γ}_{Te} ( k ) ) ) ,$$
and a new value of rear intermediary force
$$( \frac{1}{τ} \frac{am}{a + b} {ɛ}_{i γ} ( k ) )$$
by adding to the current value of rear intermediary force
$$( \frac{1}{τ} \frac{am}{a + b} {ɛ}_{i γ} ( k - 1 ) )$$
another value proportional to the first discrepancy
$$( \frac{1}{τ} \frac{am}{a + b} ⊤ ( {γ}_{T} ( k ) - {γ}_{Te} ( k ) ) ) ;$$
determining the new values of estimated front force (F_{yFe}(k)) and estimated rear force (F_{yRe}(k)) by applying to the new values of front and rear intermediary forces a correcting processing operation consisting in adding to the new value of front intermediary force
$$( \frac{1}{τ} \frac{bm}{a + b} {ɛ}_{i γ} ( k ) )$$
a value proportional to the second discrepancy
$$( \frac{1}{τ} \frac{J}{a + b} {ɛ}_{V ψ} ( k ) )$$
and in subtracting from the new value of rear intermediary force
$$( \frac{1}{τ} \frac{am}{a + b} {ɛ}_{i γ} ( k ) )$$
a value proportional to the second discrepancy
$$( \frac{1}{τ} \frac{J}{a + b} {ɛ}_{V ψ} ( k ) ) .$$

15. Method for estimating, in a vehicle and in real time, a transverse force (F_{yLF}, F_{yRF}, F_{yLR}, F_{yRR}) applied by the ground to each wheel, consisting in:
equipping this vehicle with load force measuring devices adapted to supply signals representative of the load force (F_{zLF}, F_{zRF}, F_{zLR}, F_{zRR}) to which each wheel is subjected;
determining an estimated front force (F_{yFe}) and an estimated rear force (F_{yRe}) in accordance with claim 2;
determining in the processing unit the transverse force applied to the right front wheel (F_{yLF}) and to the left front wheel (F_{yLF}) as being proportional to the load of the right front wheel (F_{zRF}) and to the load of the left front wheel (F_{zLF}), respectively, and having a sum corresponding to the estimated front force (F_{yFe});
determining in the processing unit the transverse force applied to the right rear wheel (F_{yRR}) and to the left rear wheel (F_{yLR}) as being proportional to the load of the right rear wheel (F_{zRR}) and to the load of the left rear wheel (F_{zLR}), respectively, and having a sum corresponding to the estimated rear force (F_{yRe}).

16. Method for estimating, in a vehicle and in real time, a transverse force (F_{yLF}, F_{yRF}, F_{yLR}, F_{yRR}) applied by the ground to each wheel, consisting in:
equipping this vehicle with load force measuring devices adapted to supply signals representative of the load force (F_{zLF}, F_{zRF}, F_{zLR}, F_{zRR}) to which each wheel is subjected;
determining an estimated front force (F_{yFe}) and an estimated rear force (F_{yRe}) in accordance with claim 3;
determining in the processing unit the transverse force applied to the right front wheel (F_{yLF}) and to the left front wheel (F_{yLF}) as being proportional to the load of the right front wheel (F_{zRF}) and to the load of the left front wheel (F_{zLF}), respectively, and having a sum corresponding to the estimated front force (F_{yFe});
determining in the processing unit the transverse force applied to the right rear wheel (F_{yLF}) and to the left rear wheel (F_{yLF}) as being proportional to the load of the right rear wheel (F_{zRR}) and to the load of the left rear wheel (F_{zLR}), respectively, and having a sum corresponding to the estimated rear force (F_{yRe}).

17. Method for estimating, in a vehicle and in real time, a transverse force (F_{yLF}, F_{yRF}, F_{yLR}, F_{yRR}) applied by the ground to each wheel, consisting in:
equipping this vehicle with load force measuring devices adapted to supply signals representative of the load force (F_{zLF}, F_{zRF}, F_{zLR}, F_{zRR}) to which each wheel is subjected;
determining an estimated front force (F_{yFe}) and an estimated rear force (F_{yRe}) in accordance with claim 4;
determining in the processing unit the transverse force applied to the right front wheel (F_{yLF}) and to the left front wheel (F_{yLF}) as being proportional to the load of the right front wheel (F_{zRF}) and to the load of the left front wheel (F_{zLF}), respectively, and having a sum corresponding to the estimated front force (F_{yFe});
determining in the processing unit the transverse force applied to the right rear wheel (F_{yRR}) and to the left rear wheel (F_{yLR}) as being proportional to the load of the right rear wheel (F_{zRR}) and to the load of the left rear wheel (F_{zLR}) respectively, and having a sum corresponding to the estimated rear force (F_{yRe}).

18. Method for estimating, in a vehicle and in real time, a transverse force (F_{yLF}, F_{yRF}, F_{yLR}, F_{yRR}) applied by the ground to each wheel, consisting in:
equipping this vehicle with a load force estimating device adapted to supply estimated signals representative of the load force (F_{zLFe}, F_{zRFe}, F_{zLRe}, F_{zRRe}) to which each wheel is subjected;
determining an estimated front force (F_{yFe}) and an estimated rear force (F_{yRe}) in accordance with claim 2;
determining in the processing unit the transverse force applied to the right front wheel (F_{yRF}) and to the left front wheel (F_{yLF}) as being proportional to the load of the right front wheel (F_{zRF}) and to the load of the left front wheel (F_{zLF}), respectively, and having a sum corresponding to the estimated front force (F_{yFe});
determining in the processing unit the transverse force applied to the right rear wheel (F_{yRR}) and to the left rear wheel (F_{yLR}) as being proportional to the load of the right rear wheel (F_{zRR}) and to the load of the left rear wheel (F_{zLR}), respectively, and having a sum corresponding to the estimated rear force (F_{yRe}).

19. Method for estimating, in a vehicle and in real time, a transverse force (F_{yLF}, F_{yRF}, F_{yLR}, F_{yRR}) applied by the ground to each wheel, consisting in:
equipping this vehicle with a load force estimating device adapted to supply estimated signals representative of the load force (F_{zLFe}, F_{zRFe}, F_{zLRe}, F_{zRRe}) to which each wheel is subjected;
determining an estimated front force (F_{yFe}) and an estimated rear force (F_{yRe}) in accordance with claim 3;
determining in the processing unit the transverse force applied to the right front wheel (F_{yRF}) and to the left front wheel (F_{yLF}) as being proportional to the load of the right front wheel (F_{zRF}) and to the load of the left front wheel (F_{zLF}), respectively, and having a sum corresponding to the estimated front force (F_{yFe});
determining in the processing unit the transverse force applied to the right rear wheel (F_{yRR}) and to the left rear wheel (F_{yLR}) as being proportional to the load of the right rear wheel (F_{zRR}) and to the load of the left rear wheel (F_{zLR}), respectively, and having a sum corresponding to the estimated rear force (F_{yRe}).

20. Method for estimating, in a vehicle and in real time, a transverse force (F_{yLF}, F_{yRF}, F_{yLR}, F_{yRR}) applied by the ground to each wheel, consisting in:
equipping this vehicle with a load force estimating device adapted to supply estimated signals representative of the load force (F_{zLFe}, F_{zRFe}, F_{zLRe}, F_{yRRe}) to which each wheel is subjected;
determining an estimated front force (F_{yFe}) and an estimated rear force (F_{yRe}) in accordance with claim 4;
determining in the processing unit the transverse force applied to the right front wheel (F_{yRF}) and to the left front wheel (F_{yLF}) as being proportional to the load of the right front wheel (F_{zRF}) and to the load of the left front wheel (F_{zLF}), respectively, and having a sum corresponding to the estimated front force (F_{yFe});
determining in the processing unit the transverse force applied to the right rear wheel (F_{yRR}) and to the left rear wheel (F_{yLR}) as being proportional to the load of the right rear wheel (F_{zRR}) and to the load of the left rear wheel (F_{zLR}), respectively, and having a sum corresponding to the estimated rear force (F_{yRe}).
